(19) United States
(12) Patent Application Publication
(10) Pub. No.: US 2008/0016725 A1
(43) Pub. Date: Jan. 24, 2008

(54) Universal digging attachment for skid loaders

(76) Inventor: William R. Boehm, Fremont, IN (US)

Correspondence Address: LITMAN LAW OFFICES, LTD., P.O. BOX 15035, CRYSTAL CITY STATION, ARLINGTON, VA, 22215, US

(21) Appl. No.: 11/488,594

(22) Filed: Jul. 19, 2006

(51) Int. Cl. A01G 23/06

(52) U.S. Cl. 37/302

(57) ABSTRACT

The digging attachment for skid loaders is a digging device for removing trees, bushes, and other plants. The universal digging attachment may also be used for other purposes, such as making trenches, digging post holes, and the like. The device comprises a spade blade at the end of an elongate boom. A frame, which has a rear face and a front face, has an attachment plate attached to the front face. The boom is rigidly to a lower central region of the attachment plate so that the spade extends away from the attachment plate. When the digging attachment is attached to the skid loader, an operator of the skid loader can manipulate the digging attachment to dig into soil and remove a plant from the soil in the vicinity of the plant with a minimal amount of disruption to the soil.

### BACKGROUND OF THE INVENTION

1. Field of the Invention

The present invention relates to digging machines and attachments for heavy equipment, and more particularly, to a universal digging attachment for skid loaders.

2. Description of the Related Art

Front end skid steer loaders (such as those known under the name “BOBCAT®”), while relatively small in size as compared to many tractors, are universally equipped with powerful hydraulic units for operating their loader buckets. A hydraulic pump operated by the engine of the machine provides hydraulic fluid under extremely high pressure to the hydraulic cylinders connected to the loader bucket, which are, in turn, selectively actuated to operate the bucket through its range of motion.

A variety of earth moving machines are available with digging attachments that are operable from the rear of the machine. However, such machines require the operator to continually turn around during digging operations. There is a need for a digging attachment that can be attached to the front end of a skid loader for light duty digging operations to take advantage of the economy, ease of operation, and maneuverability of the machine.

Japanese Patent No. 5-112,962, published May 7, 1993 to Shimozato Masami, appears to show a knife attachable to a bucket of an excavator that can be rotated and used to dig a furrow for sod.

The above patent does not show the present invention as claimed. Thus, a digging attachment for skid loaders solving the aforementioned problems is desired.

### SUMMARY OF THE INVENTION

The universal digging attachment for skid loaders is a digging device for removing trees, bushes, and other plants. The universal digging attachment may also be used for other purposes, such as making trenches, digging post holes, and the like. The attachment comprises a spade blade also referred to herein simply as “the spade”) rigidly attached to the end of an elongate boom. A generally rectangular frame has a rear face adapted for attachment to the hydraulic actuators and swing arms of a skid loader, and a front face having a generally rectangular attachment plate attached thereto.

The boom extends from a lower central region of the attachment plate so that the spade extends away from the attachment plate. When the universal digging attachment is attached to the skid loader, an operator of the skid loader can manipulate the universal digging attachment to dig into soil and remove a plant with a minimal amount of disruption to the soil.

These and other features of the present invention will become readily apparent upon further review of the following specification and drawings.

### BRIEF DESCRIPTION OF THE DRAWINGS

FIG. 1 is an environmental, perspective view of a universal digging attachment for skid loaders according to the present invention.

FIG. 2 is a rear perspective view of a universal digging attachment for skid loaders according to the present invention.

FIG. 3 is a side view of the universal digging attachment for skid loaders according to the present invention, shown partially in section.

Similar reference characters denote corresponding features consistently throughout the attached drawings.

### DETAILED DESCRIPTION OF THE PREFERRED EMBODIMENT

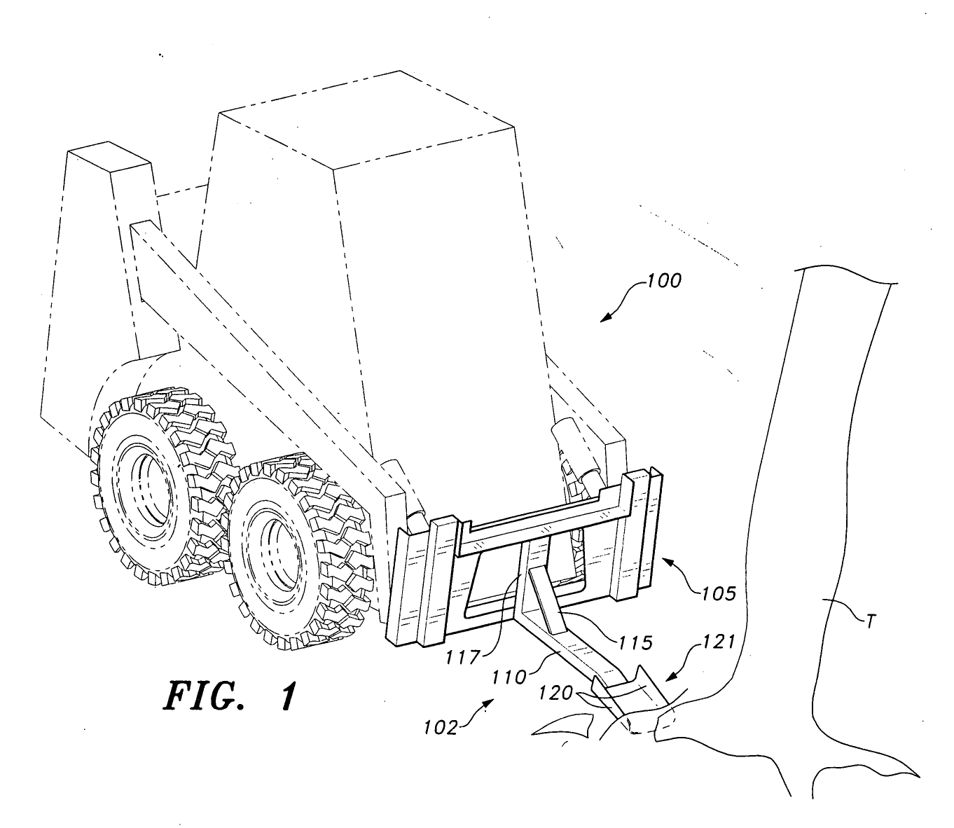

As shown in FIGS. 1-3, the present invention is a universal digging attachment 102 for skid loaders. The attachment 102 is a digging device for removing trees, bushes, and other plants. The universal digging attachment 102 may also be used for other purposes, such as making trenches, digging post holes, and the like. The attachment 102 includes a spade blade 121 (also referred to herein as a “spade”) disposed at the end of an elongate spade boom 110, the combination being rigidly attached to a frame 105. The frame 105, which has a rear face R and a front face F, is formed a plurality of vertical frame members 202 and horizontal frame members 205a and 205b and has a generally rectangular attachment plate 214 attached to the front face F.

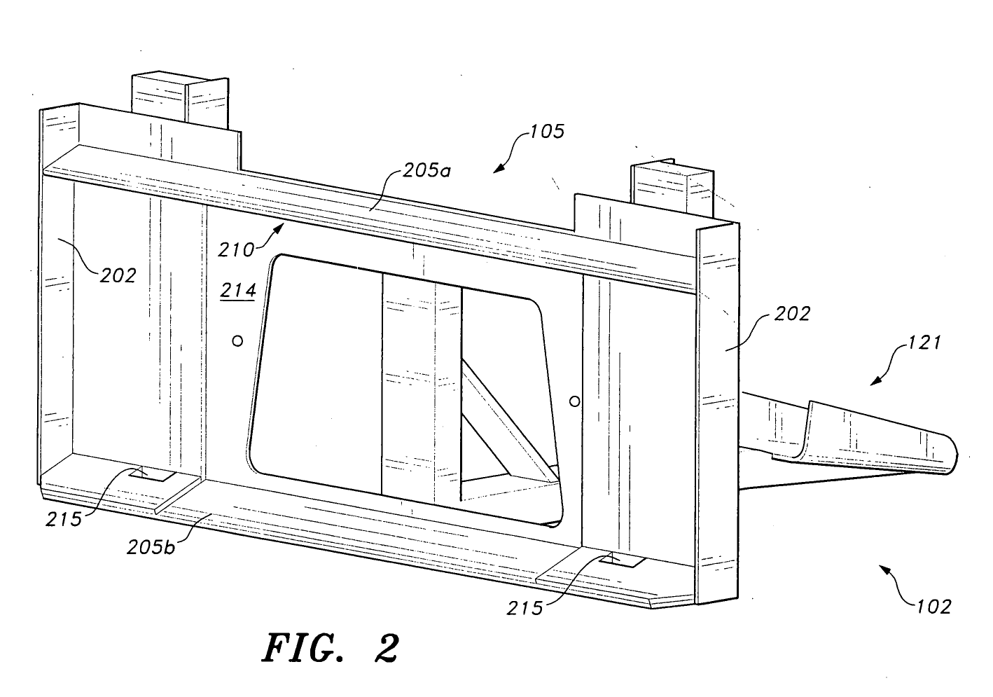

As shown in FIG. 2, top horizontal frame member 205a is canted upward as it extends to join an upper region of attachment plate 214 at the rear section R of the attachment plate 214, being supported laterally by vertical frame members 202, in order to provide a lip 210 under which a locking plate or attachment shoe (not shown) of the loader 100 may fit to provide securement of the upper region of the attachment plate 214 to the loader 100. Lower horizontal frame member 205b is also canted upward as it extends to join a lower region of attachment plate 214 at the rear section R of the attachment plate. Defined within the lower horizontal frame member 205b are two attachment retaining apertures 215, which are located proximate to opposite ends of the horizontal frame member 205b. The attachment retaining apertures 215 are formed so that they can accept corresponding attachment pins (not shown) of the loader 100 for quick-releasable securement of the universal digging attachment 202 to a backing plate attached to the hydraulic actuators and swing arms of the loader 100.

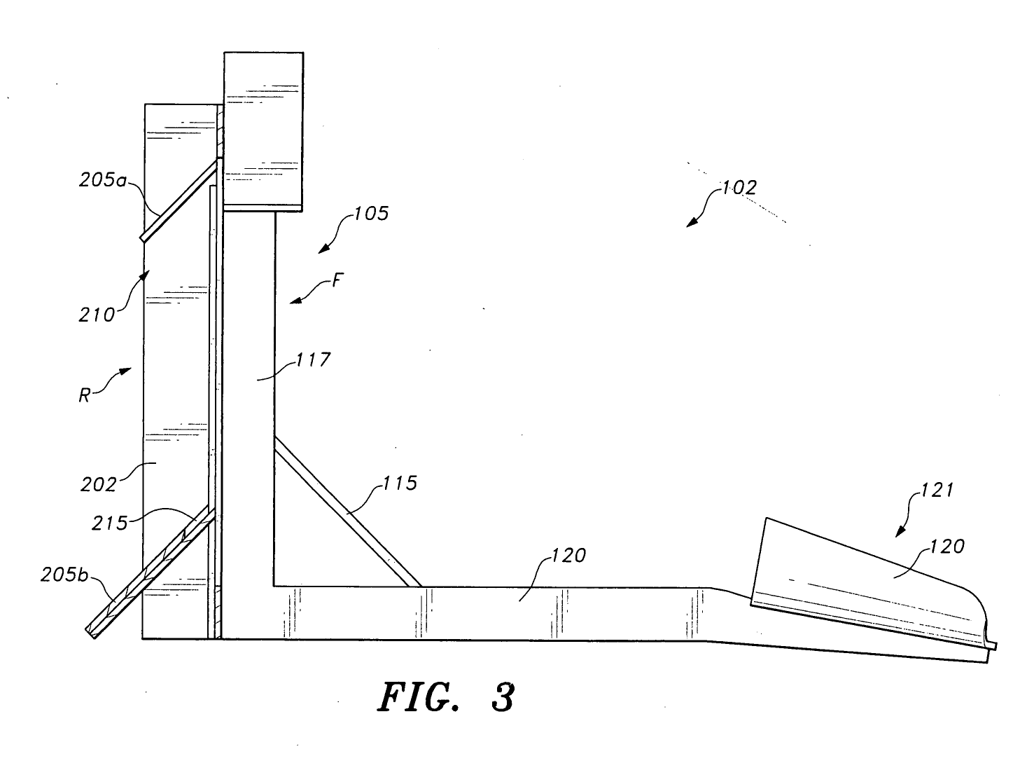

As most clearly shown in FIG. 3, the attachment of the spade boom 110 and spade 121 to the frame 105 is preferably at a lower central region of front section F of the attachment plate 214 so that the spade 121 extends away from the attachment plate 214 at an advantageously low height relative to the rest of the frame 105. The elongate spade boom 110 has a substantially uniform linear dimension as it extends away from the attachment plate 214. However, proximate to the free end of the spade boom 110, an upper surface of the spade boom 110 may be angled down to create a downward sloping, tapered free end.

Alternatively, upper and lower surfaces may be tapered, or neither surface may be tapered. In the embodiment shown in FIGS. 1-3, the spade 121 is attached to the upper, tapered surface at the free end of the spade boom 110. The tapered surface at the free end of the spade boom 110 may be notched to accept a thickness of the blade portion of spade 121. The attachment of spade 121 to spade boom 110 may be via welding, bolting, riveting, and the like. Alternatively spade boom 110 and spade 121 may be of a unitary, i.e., one-piece construction.

The spade 121 has a slightly arcuate, slightly tapered front end to provide a leading edge capable of slicing through various grades of soil, as well as slicing through obstacles, such as tree roots and the like. Moreover, tapered vertical sidewalls 120 are provided to allow spade 121 to be used as a shovel to transport dirt, debris, and the like without spillage. The spade 121 may be constructed of, for example, without limitation, fabricated metal, casting, forging, and the like.

According to the present invention, the spade 121 is advantageously scaled to similar dimension and size as a typical handheld spade tool instead of being scaled to the size of the loader. Representative dimensions of the spade 121 may be approximately 8½″ wide, 9½″ long and approximately 3″ deep. The small-scale spade 121 provides a mechanical advantage when used with the elongate spade boom 110 and hydraulic actuator power of the loader 100. Since pressure is equal to force÷area, the relatively small area of edge surfaces of the spade 121, in combination with the relatively large thrusting forces provided by the hydraulically powered loader skid 100, can create extremely high pressure points that can cut through a work surface, such as hard, rocky soil, or the large diameter roots of a mature tree. Subsequent to cutting a target work surface, moving of the debris is facilitated by the lever action of elongate spade boom 110 in combination with the torque/lifting power of the loader 100.

Opposing ends of an angled spade boom brace 115 may be attached to a central vertical support member 117 of the frame 105, and to the spade boom 110, to provide additional stability and strength of the attachment of the spade boom 110 to the frame 105. While the spade boom 110 may be of any workable length, the length is preferably limited to provide the capability of the loader 100 to position the spade 121 vertically above a work surface.

When the universal digging attachment 102 is attached to the skid loader 100, an operator, using hydraulic actuators of the skid loader 100, can manipulate the universal digging attachment 102 to dig into soil and remove a plant from the soil in the vicinity of the plant with a minimal amount of disruption to the soil. Due to the power and/or highly maneuverable traction of the skid steering front loader, the digging attachment 102 can be pushed through a variety of ground types in addition to sandy or loosely compacted soil. The digging attachment 102 can advantageously be used to dig out both small and large trees, including 70-80 ft tall trees. The digging attachment 102 can also be used to make trenches, dig post holes, and dig holes to plant trees and shrubs and the like.

Referring again to FIG. 1, the digging attachment 102 is shown cutting through a root of the mature tree T. This root cutting process can be continued around the entire tree T. Subsequently arms of the loader 100 can raise the universal digging attachment 102 to a height above the ground, e.g., 4-5′. Then, using the loader 100, an operator can push the spade 121 into the tree T until the weight of the tree tilting causes the tree T (having been severed from its roots) to fall to the ground while also uplifting the root ball of the tree from the ground.

It is to be understood that the present invention is not limited to the embodiment described above, but encompasses any and all embodiments within the scope of the following claims.

I claim:

1. A digging attachment for skid loaders, comprising:
an upper horizontal frame member, a lower horizontal frame member, and opposing vertical frame members joined to opposing ends of the horizontal members in order to form a substantially rectangular frame having a front face and a rear face, the rear face being adapted for attachment to opposing hydraulic actuators and swing arms of a skid loader;
a generally rectangular attachment plate attached to the front face of the frame;
an elongated boom extending from a central portion of the attachment plate; and
a spade blade rigidly attached to, and extending from, the boom.

2. The universal digging attachment according to claim 1, wherein said spade blade has an arcuate, tapered front end defining a leading edge capable of slicing through various grades of soil and obstacles.

3. The universal digging attachment according to claim 1, wherein said spade blade has vertical sidewalls for transporting dirt and debris without spillage.

4. The universal digging attachment according to claim 3, wherein the vertical sidewalls of said spade blade taper downward extending toward a front of the spade.

5. The universal digging attachment according to claim 1, wherein said spade blade is substantially narrower than said frame and said attachment plate.

6. The universal digging attachment according to claim 1, wherein said spade has a width of approximately 8½″, a length of approximately 9½″, and a depth of approximately 3″.

7. The universal digging attachment according to claim 1, said boom has a substantially uniform linear width.

8. The universal digging attachment according to claim 7, wherein said boom has an upper surface, the upper surface having a downward slope proximate said spade blade, said blade being at least partially mounted on the tapered upper surface so that said blade tapers downward.

9. The universal digging attachment according to claim 1, wherein further comprising:
a post extending normal to said boom, the post being rigidly attached to said attachment plate; and
a brace extending between the post and said boom for supporting said boom.

10. The universal digging attachment according to claim 1, wherein said upper and lower horizontal frame members slope downward from front to rear, said upper horizontal frame member forming a lip adapted for hooking over a projection of a skid loader backing plate, said lower horizontal frame member having apertures defined therein adapted for receiving corresponding attachment pins of the skid loader for attaching the digging attachment to the skid loader.
